(19) United States
(12) Patent Application Publication
(10) Pub. No.: US 2013/0133265 A1
(43) Pub. Date: May 30, 2013

(54) WINDOW REGULATOR

(71) Applicants: Kenichirou SEO, Takarazuka-shi (JP); Kenji MATSUMOTO, Takarazuka-shi (JP)

(72) Inventors: Kenichirou SEO, Takarazuka-shi (JP); Kenji MATSUMOTO, Takarazuka-shi (JP)

(73) Assignee: HI-LEX CORPORATION, Takarazuka-shi (JP)

(21) Appl. No.: 13/483,526

(22) Filed: May 30, 2012

(30) Foreign Application Priority Data
May 31, 2011 (JP) 2011-122813

(51) Int. Cl. E05F 15/00

(52) U.S. Cl. CPC E05F 15/00
USPC 49/352

(57) ABSTRACT

A window regulator is provided with a driving unit, a drum, a carrier plate, a wire, and wire-ends provided at both ends of the wire. The drum has a shape of a cylinder having an upper surface, a lower surface, and a side surface. The drum has a slot portion having a length substantially the same as the length of the wire-end, and a wire-end housing portion disposed to deviate from the slot in the axial direction of the drum. The wire-end housing portion has a height substantially the same as the thickness of the wire-end, with a top surface provided on the side of the upper surface of the drum and a bottom surface provided on the side of the lower surface of the drum. The drum has a guide surface for guiding the wire-end, and a wire-end engagement portion, and a wire guide.

### CROSS-REFERENCE TO RELATED APPLICATIONS

This application claims priority under 35 U.S.C. §119 to Japanese Patent Application No. 2011-122813 filed on May 31, 2011. The entire disclosure of Japanese Patent Application No. 2011-122813 is hereby incorporated herein by reference.

### BACKGROUND OF THE INVENTION

1. Field of the Invention

The present invention is related to window regulators used in doors of vehicles.

2. Background Information

A window regulator is used while being fixed to an inner panel of a vehicle, and generally includes a carrier plate to which a window glass is connected, a wire having wire-ends, one of which being connected to a drum and the other one of which being connected to the carrier plate, and a driving unit configured to drive the drum to wind in or reel out the wire, thereby vertically moving the window glass with the carrier plate.

Japanese Examined Utility Model Application Publication No. H5-1590 discloses a window regulator, in which a wire-end provided at one end of a wire is moved radially inward of a drum, and then the wire-end is moved in the axial direction of the wire so that the wire-end gets over an elastic protrusion formed on the drum. As a result, the wire-end is connected to the drum in a way so as to prevent disconnection between the wire-end and the drum.

Japanese Unexamined Utility Model Application Publication No. H3-29686 discloses a window regulator, in which a wire-end provided at one end of a wire is moved radially inward of a drum, and then the wire-end is moved in the axial direction of the wire. As a result, the wire-end is connected to the drum in a way so as to prevent disconnection between the wire-end and the drum.

However, according to the window regulators disclosed in both prior arts, the wire-end is moved radially inward, and then the wire-end is moved in the axial direction of the wire by a length corresponding to the length of the wire-end or more to be connected to the drum, so that the wire-end is less likely to be disengaged from the drum. In other words, according to the window regulators, when connecting the wire-end to the drum, it is necessary to move the wire-end in the axial direction of the wire by a large extent.

Therefore, according to the window regulators, after the wire-end provided at another end of the wire is connected to the carrier plate, the movement amount of the wire should be large, during the assembly operation for connecting a wire-end provided at a one end of the wire to the drum or during the operation of causing tension in the wire after the assembly operation. In other words, the wire-end should be moved in the axial direction of the wire by a large extent for connecting the wire-end to the drum. As a result, the assembly operation becomes troublesome.

### SUMMARY

The present invention was conceived in view of the above-described problems, and the object of the present invention is to provide a window regulator in which the wire-end is less likely to be disengaged from the drum, while the assembly operation becomes easier by reducing the movement amount of the wire in the operation of causing tension in the wire.

In order to achieve the above-described object, a window regulator according to an aspect of the present invention includes a driving unit, a drum, a carrier plate, and a wire. A driving force is transmitted from the driving unit to the drum. A window glass is connected to the carrier plate. The wire includes wire-ends provided at both ends thereof including one end connected to the drum and another end connected to the carrier plate. The driving force from the driving unit moves the carrier plate up and down.

The drum has a shape of a cylinder having an upper surface, a lower surface, and a side surface formed with a wire groove around which the wire is wound. The drum has a slot, a wire-end housing portion, a guide surface, a wire engagement portion, and a wire guide. The slot is formed on a portion of the side surface near the upper surface, and has a length in the circumferential direction of the drum substantially the same as the length of the wire-end in the axial direction of the wire, and has a height in the axial direction of the drum substantially the same as the thickness of the wire-end. The wire-end housing portion is continuously formed radially inward from the slot in a way that the wire-end housing portion has a height substantially the same as the thickness of the wire-end. The wire-end housing portion has a size capable of holding the wire-end, with a top surface provided on the side of the upper surface of the drum and a bottom surface provided on the side of the lower surface of the drum. The wire-end housing portion is arranged to deviate from the slot in the axial direction of the drum. The guide surface is configured to guide the wire-end from the slot to the wire-end housing portion. The wire-end engagement portion is disposed at a portion of the wire-end housing portion adjacent to the slot in the circumferential direction of the drum, and is configured to engage the wire-end in the axial direction of the wire. The wire guide connects the wire-end engagement portion and the wire groove in the circumferential direction of the drum.

In the window regulator according to an aspect of the present invention, the drum, to which a driving force is transmitted from the driving unit, includes the wire-end engagement portion engaging the wire-end in the wire-end housing portion, which holds the wire-end provided at one end of the wire, in the axial direction of the wire. The wire-end engagement portion is formed adjacent to the slot, through which the wire-end is inserted into the wire-end housing portion. Accordingly, according to the window regulator, when causing tension in the wire, the wire-end inserted in the wire-end housing portion is slightly moved in the axial direction of the wire and engaged with the wire-end engagement portion, in order to connect the wire-end to the drum, thereby making the assembly operation easier. In addition, according to the window regulator, the wire-end housing portion is formed to deviate from the slot in the axial direction of the drum, and the guide surface is provided for guiding the wire-end from the slot to the wire-end housing portion. Accordingly, according to the window regulator, since the guide surface functions as a stopper for preventing the wire-end from being disengaged from the wire housing portion, the wire-end is less likely to be disengaged from the wire-end housing portion.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a front view of the window regulator according to the present invention.

FIG. 2A is an enlarged plain view of the wire-end.

FIG. 2B is an enlarged front view of the wire-end.

FIG. 3A is an enlarged plain view of the drum.

FIG. 3B is an enlarged back view of the drum.

FIG. 4A is an enlarged cross-sectional view of the drum, and a cross-section A-A.

FIG. 4B is an enlarged cross-sectional view of the drum, and a cross-section B-B.

FIG. 5A is an enlarged plain view for explaining a method of connecting the wire-end to the drum.

FIG. 5B is an enlarged C-C cross-sectional view for explaining a method of connecting the wire-end to the drum.

FIG. 6A is an enlarged plain view for explaining a method of connecting the wire-end to the drum.

FIG. 6B is an enlarged D-D cross-sectional view for explaining a method of connecting the wire-end to the drum.

FIG. 7A is an enlarged plain view for explaining a method of connecting the wire-end to the drum.

FIG. 7B is an enlarged E-E cross-sectional view for explaining the connection method of the wire-end.

### DETAILED DESCRIPTION OF THE PREFERRED EMBODIMENTS

Selected embodiments of the present invention will now be described with reference to the drawings. It will be apparent to those skilled in the art from this disclosure that the following descriptions of the embodiments of the present invention are provided as examples only and are not meant to limit the invention defined by the appended claims and their equivalents.

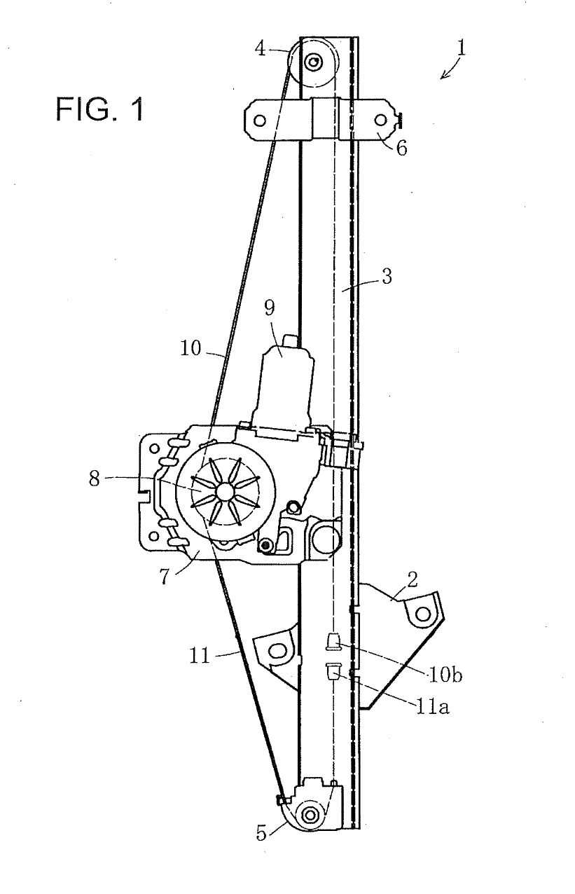

An embodiment will now be explained with reference to the figures. The window regulator 1 is used while being fixed to an inner panel of a door of a vehicle. The window regulator 1 includes, as shown in FIG. 1, a carrier plate 2 to which a window glass (not shown) is connected, a guide rail 3 configured to guide the carrier plate 2 vertically, wire guides 4 and 5 respectively fixed to an upper portion and a lower portion of the guide rail 3, a bracket 6 fixed to the guide rail 3 at a position a predetermined distance lower than the wire guide 4 and that is used to fix the door (not shown) to the inner panel, a housing 7 fixed to a center portion in the longitudinal direction of the guide rail 3, a drum 8 accommodated within the housing 7, and a driving unit 9 provided on the housing 7 and configured to drive the drum 8 to rotate.

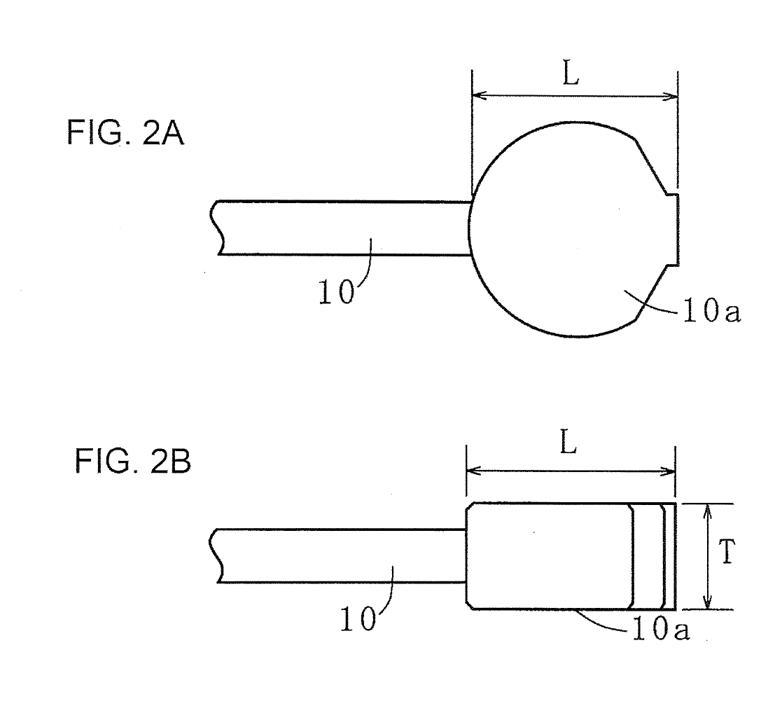

In the window regulator 1, the wire 10 is wound around the wire guide 4 such that a wire-end 10a (shown in FIG. 2) at a fist end of the wire 10 is connected to the drum 8 and a wire-end 10b at another end of the wire 10 is connected to the carrier plate 2. The wire 11 is wound around the wire guide 5 such that a wire-end (not shown) at a one end of the wire 11 is connected to the drum 8 and a wire-end 11a at another end of the wire 11 is connected to the carrier plate 2.

According the window regulator 1, with the above-described structure, the driving unit 9 drives the drum 8 to wind the wire 10 around the drum 8 while releasing the wire 11 from the drum 8 toward another end, thereby moving the window glass (not shown) upward. Also, the driving unit 9 reels out the wire 10 from the drum 8 toward the another end while winding the wire 11 around the drum 8, thereby moving the window glass downward.

The window regulator 1 has characterizing features in the structure of the drum 8, and it may employ known technologies for components other than the drum 8. Accordingly, the structure of the drum 8 will be mainly explained hereinafter.

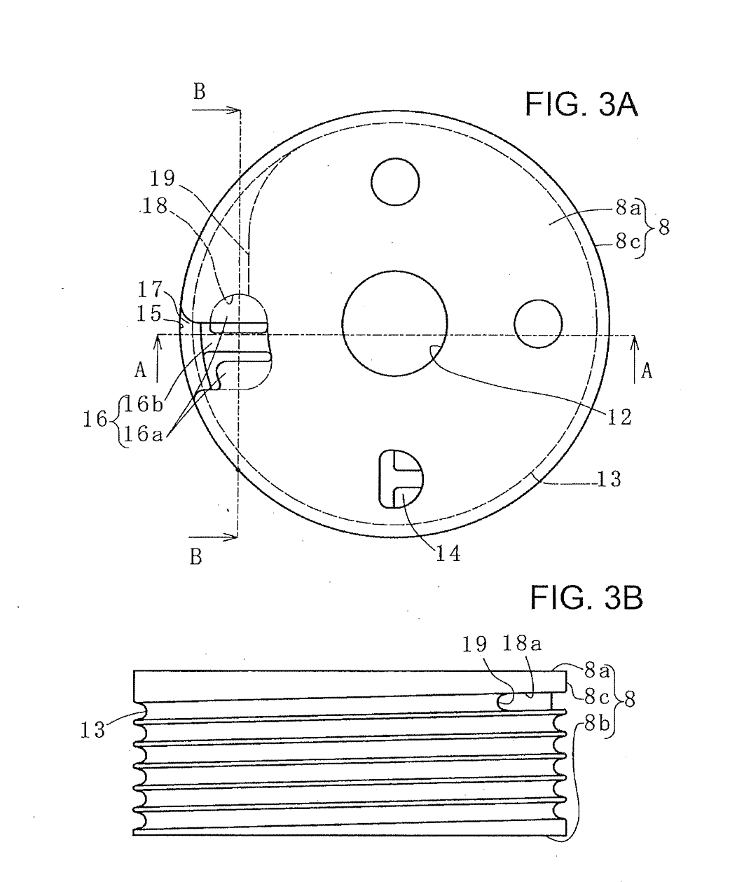

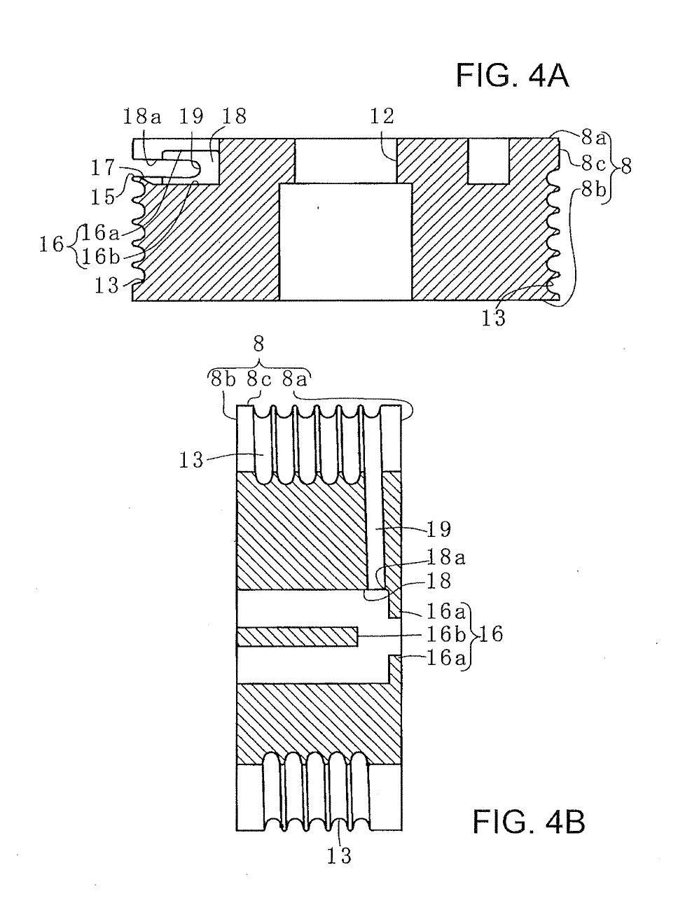

As shown in FIGS. 3 and 4, the drum 8 has the shape of a cylinder, and has an upper surface 8a, a lower surface 8b and a side surface 8c. The drum 8 is formed with a shaft insert hole 12 in the center, the shaft insert hole 12 having a circular opening at the upper surface 8a and a square opening at the lower surface 8b. Into the shaft insert hole 12, a shaft (not shown) rotatably supporting the drum 8 in the housing 7 shown in FIG. 1 is inserted. The drum 8 is also formed with a wire groove 13 on the side surface 8c, around which the wires 10 and 11 may be wound. In addition, the drum 8 has a through hole (not shown) between the upper surface 8a and the lower surface 8b, and a wire-end connection portion (not shown) formed at a portion of the through hole near the lower surface 8b. The wire-end connection portion is connected to the wire-end (not shown) provided at the one end of the wire 11 shown in FIG. 1.

Furthermore, the drum 8 is formed with a slot 15 at the side surface 8c near the upper surface 8a, into which the wire-end 10a of the wire 10 shown in FIG. 2 is inserted. The drum 8 is also formed with a wire-end housing portion 16, which is formed continuously from the slot 15 for holding the wire-end 10a. The drum 8 is also formed with a guide surface 17 between the slot 15 and wire-end housing portion 16 and configured to guide the wire-end 10a from the slot 15 to the wire-end housing portion 16. The drum 8 is also formed with a wire-end engagement portion 18 configured to engage the wire-end 10a accommodated within the wire-end housing portion 16 along the axial direction of the wire 10. The drum 8 is also formed with a wire guide 19 configured to guide a portion of the wire 10 near the wire-end 10a.

The slot 15 opens, as shown in FIGS. 3A and 4A, at the upper surface 8a and the side surface 8c of the drum 8. Into the slot 15, the wire-end 10a of the wire 10 shown in FIG. 2 can be inserted. The slot 15 has a length in a circumferential direction of the drum 8 substantially the same as the length L of the wire-end 10a in the axial direction of the wire 10. The slot 15 has a height in the axial direction of the drum 8 substantially the same as the thickness T of the wire-end 10a. It is acceptable that the slot 15 does not open at the upper surface 8a, and may instead be formed in a position near the upper surface 8a. The position near the upper surface 8a means a position of the slot 15 where the distance from the slot 15 to the upper surface 8a is shorter than the distance from the slot 15 to the lower surface 8b along the vertical direction in FIG. 3B.

The wire-end housing portion 16 is, as shown in FIGS. 3A and 4, formed continuously from the slot 15. The wire-end housing portion 16 is formed at a position deviated by a predetermined amount relative to the slot 15, inward in the radial direction of the drum 8 and downward in the axial direction of the drum 8. The predetermined deviation amount is preferably determined depending on the shape of the wire-end 10a such that the wire-end 10a does not disengage from the wire-end housing portion 16. If the deviation is too small, the wire-end 10a may disengage from the wire-end housing portion 16. If the deviation is too large, it becomes difficult to assemble the wire-end 10a into the wire-end housing portion 16. The wire-end housing portion 16 includes top surfaces 16a provided on the side of the upper surface 8a of the drum 8, and a bottom surface 16b provided on the side of the lower surface 8b of the drum 8. The surfaces 16a oppose each other on two sides and sandwiches an opening. The wire-end housing portion 16 can accommodate the wire-end 10a of the wire 10 shown in FIG. 2. It should be noted that the wire-end housing portion 16 has a height in the axial direction of the drum 8 substantially the same as the thickness T of the wire-end 10a.

The inner surface 17 is, as especially shown in FIG. 4A, a slanted surface slanted from a periphery of the slot 15 on the side of the lower surface 8b toward the bottom surface 16b of the wire-end housing portion 16, so that the inner surface 17 guides the wire-end 10a from the slot 15 to the wire-end housing portion 16.

The wire-end engagement portion 18 is, as especially shown in FIG. 3A, formed at the side surface of the wire-end housing portion 16 adjacent to the slot 15 in the circumferential direction of the drum 8. The wire-end engagement portion 18 has a shape that corresponds to the shape of a portion of the wire-end 10a of the wire in FIG. 2, i.e., a concave segment in a semicircle. In addition, the wire-end engagement portion 18 is, as especially shown in FIG. 4A, formed with a slit 18a through which a portion of the wire 10 near the wire-end 10a is inserted into the wire-end engagement portion 18. The slit 18a opens at the side surface 8c of the drum 8.

The wire guide 19 is, as especially shown in FIG. 3A, formed as a groove connecting the wire-end engagement portion 18 and the wire groove 13 in the circumferential direction of the drum 8. Accordingly, the wire guide 19 defines the bottom of the slit 18a and guides a portion of the wire 10 near the wire-end 10a.

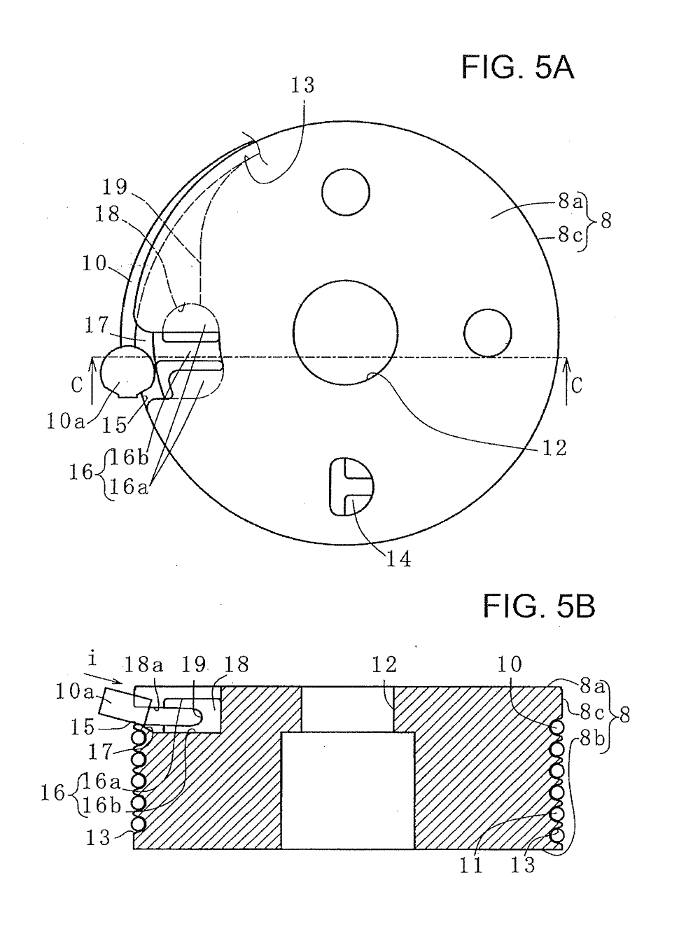

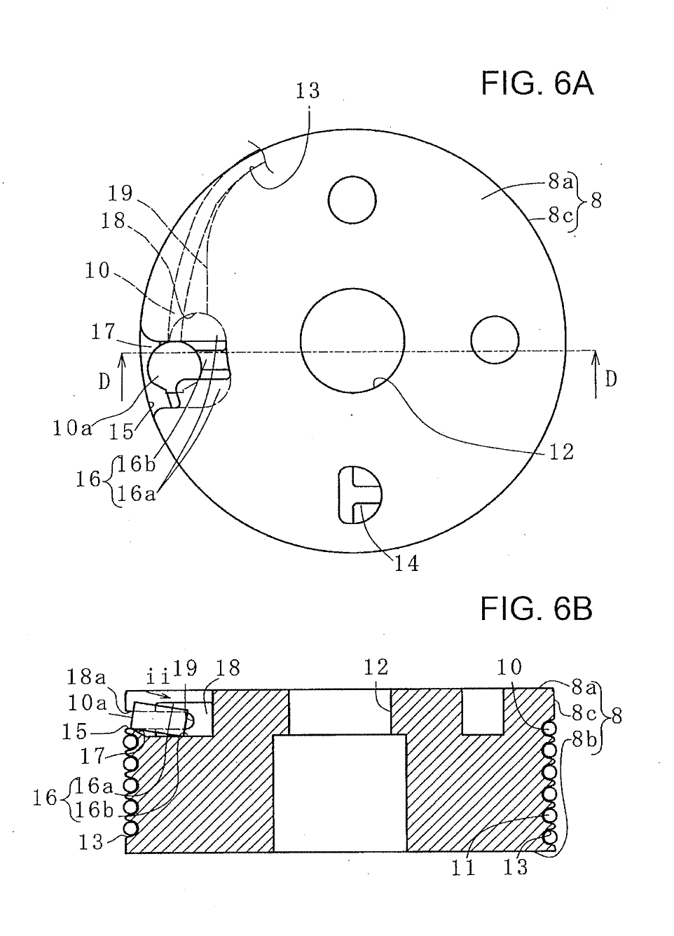

The wire-end 10a of the wire 10 is connected to the drum 8, whose parts have been described above, as follows. First, as shown in FIG. 5, the wire 10 is wound around the wire groove 13, and then the wire-end 10a is inserted into the slot 15 (arrow i in FIG. 5B). Since the slot 15 opens at the upper surface 8a and the side surface 8c of the drum 8, it is easy to insert the wire-end 10a from an obliquely upward direction. In addition, inserting the wire-end 10a into the slot 15 allows a portion of the wire 10 near the wire-end 10a to be inserted into the slit 18a formed at the wire-end engagement portion 18 and into the wire guide 19. Then, as shown in FIG. 6, when the wire-end 10a is further inserted into the slot 15 (an arrow ii in FIG. 6B), the wire-end 10a is accommodated into the wire-end housing portion 16 after being guided by the guide surface 17.

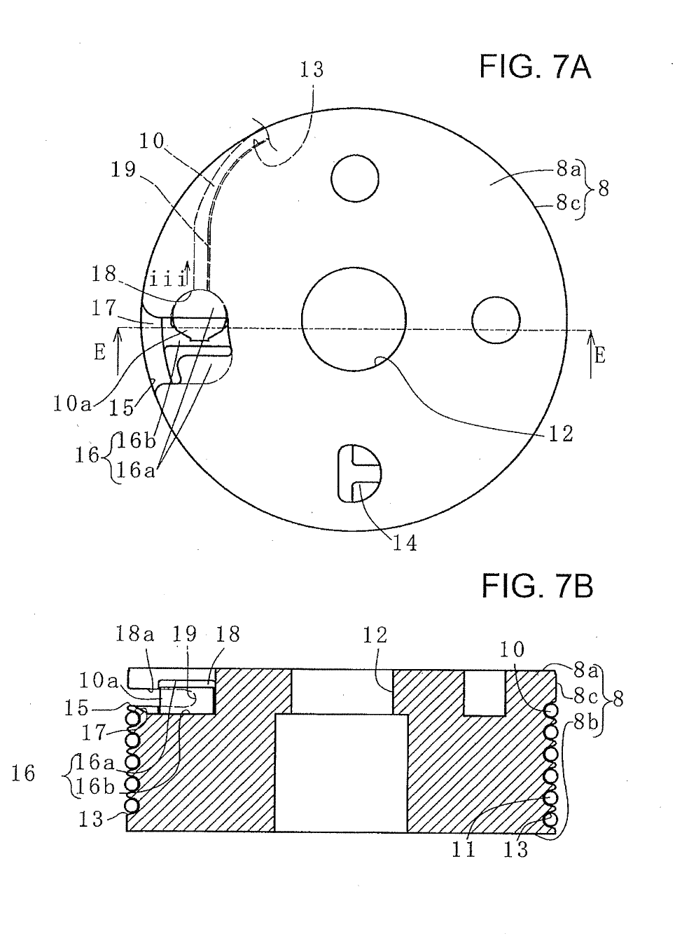

Then, as shown in FIG. 7, when the wire 10 is moved toward the other side in the axial direction (an arrow iii in FIG. 7A), the end surface of the wire-end 10a near the wire 10 gets into contact with the wire-end engagement portion 18. This contact allows the wire-end 10a to be engaged in the axial direction of the wire 10. At the same time, the portion of the wire 10 near the wire-end 10a is guided by the wire guide 19. Accordingly, the wire-end 10a is finally connected to the drum 8.

According to the window regulator 1 of the embodiment described above, in the drum 8, the wire-end engagement portion 18 to engage the wire-end 10a in the axial direction of the wire 10 is provided within the wire-end housing portion 16 which accommodates the wire-end 10a provided at the one end of the wire 10. The wire-end engagement portion 18 is adjacent, in the circumferential direction of the drum 8, to the slot 15, through which the wire-end 10a is inserted into the wire-end housing portion 16. Therefore, according to the window regulator 1, when causing tension in the wire 10, the wire-end 10a inserted into the wire-end housing portion 16 through the slot 15 is moved toward the another end of the wire 10, so that the wire-end 10a can be engaged with the wire-end engagement portion 18 by moving the wire-end 10a along a distance in the axial direction of the wire 10 shorter than the length L of the wire-end 10a Accordingly, according to the window regulator 1, since the wire-end 10a can be connected to the drum 8, the movement amount of the wire 10 when causing tension in the wire 10 is smaller and the assembly operation is easier.

In addition, according to the window regulator 1, the wire-end housing portion 16 is formed continuously with the slot 15 in a way that the wire-end housing portion 16 is deviated radially inward of the drum 8 and downward in the axial direction of the drum 8 relative to the slot 15. Furthermore, the guide surface 17 is formed for guiding the wire-end 10a from the slot 15 to the wire-end housing portion 16. The above-described structure of the window regulator 1 allows the guide surface 17 to work as a stopper for stopping the wire-end 10a from being disengaged from the wire-end housing portion 16, so that the wire-end 10a is not likely to be disengaged from the wire-end housing portion 16.

In addition, according to the window regulator 1, the length of the slot 15 in the circumferential direction of the drum 8 is substantially the same as the length L of the wire-end 10a, and the height of the slot 15 and the wire-end housing portion 16 in the axial direction of the drum 8 is substantially the same as the thickness T of the wire-end 10a. The above-described structure of the window regulator 1 restricts the movement of the wire-end 10a accommodated within the wire-end housing portion 16, so that wire-end 10a is less likely to be disengaged from the wire-end housing portion 16.

In addition, in the window regulator 1 according to the embodiment, the guide surface 17 is slanted from the slot 15 toward the bottom surface 16b of the wire-end housing unit 16. Accordingly, it is easy to guide the wire-end 10a from the slot 15 to the wire-end housing portion 16, thereby making the assembly operation easier.

In addition, in the window regulator 1 according to the embodiment, the slot 15 opens at the upper surface 8a and the side surface 8c so that the wire-end 10a can be inserted from an obliquely upward direction of the drum 8 into the slot 15, thereby making the assembly operation easier.

The window regulator 1 shown in the embodiment is just an example of the window regulators according to the invention, and various modifications are available without departing from the spirit of the invention.

For example, a wire-end similar to the wire-end 10a provided at the one end of the wire 10 may be provided at the one end of the wire 11, and similar structures of the slot 15, the wire-end housing portion 16, the guide surface 17, the wire-end engagement portion 18 and the wire guide 19 may be provided in the drum 8 instead of the wire-end connecting portion (not shown). The above-described structure allows the wire-end attached to the one end of the wire 11 to be connected with the drum 8 in a similar way as that for the wire-end 10a.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided as examples only, and not for the purpose of limiting the invention as defined by the appended claims and their equivalents. Thus, the scope of the invention is not limited to the disclosed embodiments.

What is claimed is:

1. A window regulator comprising:
a driving unit;
a drum to which a driving force is transmitted from the driving unit;
a carrier plate to which a window glass is connected; and
a wire including wire-ends at both ends thereof including one end connected to the drum and another end connected to the carrier plate, wherein
the driving force from the driving unit moves the carrier plate up and down;
the drum has a shape of a cylinder including an upper surface, a lower surface, and a side surface formed with a wire groove around which the wire is wound,
the drum includes:
a slot formed on a portion of the side surface near the upper surface, having a length in the circumferential direction of the drum substantially the same as a length of the wire-end in the axial direction of the wire, and having a height in the axial direction of the drum substantially the same as a thickness of the wire-end;
a wire-end housing portion continuously formed radially inward from the slot, the wire-end housing portion having a height substantially the same as the thickness of the wire-end, the wire-end housing portion having a size capable of holding the wire-end and including a top surface provided on the side of the upper surface and a bottom surface provided on the side of the lower surface, the wire-end housing portion being arranged to deviate from the slot in the axial direction of the drum;
a guide surface configured to guide the wire-end from the slot to the wire-end housing portion;
a wire-end engagement portion provided at a portion in the wire-end housing portion, adjacent to the slot in the circumferential direction of the drum, and being configured to engage the wire-end in the axial direction of the wire; and
a wire guide connecting the wire-end engagement portion and the wire groove in the circumferential direction of the drum.

2. The window regulator according to claim 1, wherein the guide surface is slanted from the slot to the wire-end housing portion.

3. The window regulator according to claim 1, wherein the slot opens toward the upper surface.

4. The window regulator according to claim 2, wherein the slot opens toward the upper surface.
